(19) United States
(12) Patent Application Publication
(10) Pub. No.: US 2018/0103194 A1
(43) Pub. Date: Apr. 12, 2018

(54) IMAGE CAPTURE SYSTEMS, DEVICES, AND METHODS THAT AUTOFOCUS BASED ON EYE-TRACKING

(71) Applicant: THALMIC LABS INC., Kitchener (CA)

(72) Inventor: Sui Tong Tang, Waterloo (CA)

(21) Appl. No.: 15/839,049

(22) Filed: Dec. 12, 2017

Related U.S. Application Data
(63) Continuation of application No. 15/639,371, filed on Jun. 30, 2017.
(60) Provisional application No. 62/357,201, filed on Jun. 30, 2016.

(51) Int. Cl. H04N 5/232; G06T 7/70; G02B 27/01; G06K 9/00; H04N 5/235

(52) U.S. Cl. CPC H04N 5/23212; G06T 7/70; G02B 27/0172; G02B 2027/014; G02B 2027/0187; G06K 9/0061; H04N 5/2351; G02B 2027/0178; G06K 9/00604; G02B 2027/0138; G06T 2207/30201

(57) ABSTRACT

Image capture systems, devices, and methods that automatically focus on objects in the user's field of view based on where the user is looking/gazing are described. The image capture system includes an eye tracker subsystem in communication with an autofocus camera to facilitate effortless and precise focusing of the autofocus camera on objects of interest to the user. The autofocus camera automatically focuses on what the user is looking at based on gaze direction determined by the eye tracker subsystem and one or more focus property(ies) of the object, such as its physical distance or light characteristics such as contrast and/or phase. The image capture system is particularly well-suited for use in a wearable heads-up display to capture focused images of objects in the user's field of view with minimal intervention from the user.

### TECHNICAL FIELD

The present systems, devices, and methods generally relate to autofocusing cameras and particularly relate to automatically focusing a camera of a wearable heads-up display.

### BACKGROUND

### Description of the Related Art

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

The optical performance of a wearable heads-up display is an important factor in its design. When it comes to face-worn devices, however, users also care about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Most wearable heads-up displays presented to date employ large display components and, as a result, most wearable heads-up displays presented to date are considerably bulkier and less stylish than conventional eyeglass frames.

A challenge in the design of wearable heads-up displays is to minimize the bulk of the face-worn apparatus while still providing displayed content with sufficient visual quality. There is a need in the art for wearable heads-up displays of more aesthetically-appealing design that are capable of providing high-quality images to the user without limiting the user's ability to see their external environment.

### Autofocus Camera

An autofocus camera includes a focus controller and automatically focuses on a subject of interest without direct adjustments to the focus apparatus by the user. The focus controller typically has at least one tunable lens, which may include one or several optical elements, and a state or configuration of the lens is variable to adjust the convergence or divergence of light from a subject that passes therethrough. To create an image within the camera the light from a subject must be focused on a photosensitive surface. In digital photography the photosensitive surface is typically a charge-coupled device or complementary metal-oxide-semiconductor (CMOS) image sensor, while in conventional photography the surface is photographic film. Commonly, the focus of the image is adjusted in the focus controller by either altering the distance between the at least one tunable lens and the photosensitive surface or by altering the optical power (e.g., convergence rate) of the lens. To this end, the focus controller typically includes or is communicatively coupled to at least one focus property sensor to directly or indirectly determine a focus property (e.g., distance from the camera) of the region of interest in the field of view of the user. The focus controller can employ any of several types of actuators (e.g., motors, or other actuatable components) to alter the position of the lens and/or alter the lens itself (as is the case with a fluidic or liquid lens). If the object is too far away for the focus property sensor to accurately determine the focus property, some autofocus cameras employ a focusing technique known as “focus at infinity” where the focus controller focuses on an object at an “infinite distance” from the camera. In photography, infinite distance is the distance at which light from an object at or beyond that distance arrives at the camera as at least approximately parallel rays.

There are two categories of conventional autofocusing approaches: active and passive. Active autofocusing requires an output signal from the camera and feedback from the subject of interest based on receipt by the subject of interest of the output signal from the camera. Active autofocusing can be achieved by emitting a “signal”, e.g., infrared light or an ultrasonic signal, from the camera and measuring the “time of flight,” i.e., the amount of time that passes before the signal is returned to the camera by reflection from the subject of interest. Passive autofocusing determines focusing distance from image information that is already being collected by the camera. Passive autofocusing can be achieved by phase detection which typically collects multiple images of the subject of interest from different locations, e.g., from multiple sensors positioned around the image sensor of the camera (off-sensor phase detection) or from multiple pixel sets (e.g., pixel pairs) positioned within the image sensor of the camera (on-sensor phase detection), and adjusts the at least one tunable lens to bring those images into phase. A similar method involves using more than one camera or other image sensor, i.e., a dual camera or image sensor pair, in different locations or positions or orientations to bring images from slightly different locations, positions or orientations together (e.g., parallax). Another passive method of autofocusing is contrast detection, where the difference in intensity of neighboring pixels of the image sensor is measured to determine focus.

### BRIEF SUMMARY

Wearable heads-up devices with autofocus cameras in the art today generally focus automatically in the direction of the forward orientation of the user's head without regard to the user's intended subject of interest. This results in poor image quality and a lack of freedom in composition of images. There is a need in the art for an image capture system that enables more accurate and efficient selection of an image subject and precise focusing to that subject.

An image capture system may be summarized as including: an eye tracker subsystem to sense at least one feature of an eye of the user and to determine a gaze direction of the eye of the user based on the at least one feature; and an autofocus camera communicatively coupled to the eye tracker subsystem, the autofocus camera to automatically focus on an object in a field of view of the eye of the user based on the gaze direction of the eye of the user determined by the eye tracker subsystem.

The autofocus camera may include: an image sensor having a field of view that at least partially overlaps with the field of view of the eye of the user; a tunable optical element positioned and oriented to tunably focus on the object in the field of view of the image sensor; and a focus controller communicatively coupled to the tunable optical element, the focus controller to apply adjustments to the tunable optical element to focus the field of view of the image sensor on the object in the field of view of the eye of the user based on both the gaze direction of the eye of the user determined by the eye tracker subsystem and a focus property of at least a portion of the field of view of the image sensor determined by the autofocus camera. In this case, the capture system may further include: a processor communicatively coupled to both the eye tracker subsystem and the autofocus camera; and a non-transitory processor-readable storage medium communicatively coupled to the processor, wherein the non-transitory processor-readable storage medium stores processor-executable data and/or instructions that, when executed by the processor, cause the processor to effect a mapping between the gaze direction of the eye of the user determined by the eye tracker subsystem and the focus property of at least a portion of the field of view of the image sensor determined by the autofocus camera. The autofocus camera may also include a focus property sensor to determine the focus property of at least a portion of the field of view of the image sensor, the focus property sensor selected from a group consisting of: a distance sensor to sense distances to objects in the field of view of the image sensor; a time of flight sensor to determine distances to objects in the field of view of the image sensor; a phase detection sensor to detect a phase difference between at least two points in the field of view of the image sensor; and a contrast detection sensor to detect an intensity difference between at least two points in the field of view of the image sensor.

The image capture system may include: a processor communicatively coupled to both the eye tracker subsystem and the autofocus camera; and a non-transitory processor-readable storage medium communicatively coupled to the processor, wherein the non-transitory processor-readable storage medium stores processor-executable data and/or instructions that, when executed by the processor, cause the processor to control an operation of at least one of the eye tracker subsystem and/or the autofocus camera. In this case, the eye tracker subsystem may include: an eye tracker to sense the at least one feature of the eye of the user; and processor-executable data and/or instructions stored in the non-transitory processor-readable storage medium, wherein when executed by the processor the data and/or instructions cause the processor to determine the gaze direction of the eye of the user based on the at least one feature of the eye of the user sensed by the eye tracker.

The at least one feature of the eye of the user sensed by the eye tracker subsystem may be selected from a group consisting of: a position of a pupil of the eye of the user, an orientation of a pupil of the eye of the user, a position of a cornea of the eye of the user, an orientation of a cornea of the eye of the user, a position of an iris of the eye of the user, an orientation of an iris of the eye of the user, a position of at least one retinal blood vessel of the eye of the user, and an orientation of at least one retinal blood vessel of the eye of the user. The image capture system may further include a support structure that in use is worn on a head of the user, wherein both the eye tracker subsystem and the autofocus camera are carried by the support structure.

A method of focusing an image capture system, wherein the image capture system includes an eye tracker subsystem and an autofocus camera, may be summarized as including: sensing at least one feature of an eye of a user by the eye tracker subsystem; determining a gaze direction of the eye of the user based on the at least one feature by the eye tracker subsystem; and focusing on an object in a field of view of the eye of the user by the autofocus camera based on the gaze direction of the eye of the user determined by the eye tracker subsystem. Sensing at least one feature of an eye of the user by the eye tracker subsystem may include at least one of: sensing a position of a pupil of the eye of the user by the eye tracker subsystem; sensing an orientation of a pupil of the eye of the user by the eye tracker subsystem; sensing a position of a cornea of the eye of the user by the eye tracker subsystem; sensing an orientation of a cornea of the eye of the user by the eye tracker subsystem; sensing a position of an iris of the eye of the user by the eye tracker subsystem; sensing an orientation of an iris of the eye of the user by the eye tracker subsystem; sensing a position of at least one retinal blood vessel of the eye of the user by the eye tracker subsystem; and/or sensing an orientation of at least one retinal blood vessel of the eye of the user by the eye tracker subsystem.

The image capture system may further include: a processor communicatively coupled to both the eye tracker subsystem and the autofocus camera; and a non-transitory processor-readable storage medium communicatively coupled to the processor, and wherein the non-transitory processor-readable storage medium stores processor-executable data and/or instructions; and the method may further include: executing the processor-executable data and/or instructions by the processor to cause the autofocus camera to focus on the object in the field of view of the eye of the user based on the gaze direction of the eye of the user determined by the eye tracker subsystem. The autofocus camera may include an image sensor, a tunable optical element, and a focus controller communicatively coupled to the tunable optical element, and the method may further include determining a focus property of at least a portion of a field of view of the image sensor by the autofocus camera, wherein the field of view of the image sensor at least partially overlaps with the field of view of the eye of the user. In this case, focusing on an object in a field of view of the eye of the user by the autofocus camera based on the gaze direction of the eye of the user determined by the eye tracker subsystem may include adjusting, by the focus controller of the autofocus camera, the tunable optical element to focus the field of view of the image sensor on the object in the field of view of the eye of the user based on both the gaze direction of the eye of the user determined by the eye tracker subsystem and the focus property of at least a portion of the field of view of the image sensor determined by the autofocus camera. The autofocus camera may include a focus property sensor, and determining a focus property of at least a portion of a field of view of the image sensor by the autofocus camera may include at least one of: sensing a distance to the object in the field of view of the image sensor by the focus property sensor; determining a distance to the object in the field of view of the image sensor by the focus property sensor; detecting a phase difference between at least two points in the field of view of the image sensor by the focus property sensor; and/or detecting an intensity difference between at least two points in the field of view of the image sensor by the focus property sensor.

The method may include effecting, by the processor, a mapping between the gaze direction of the eye of the user determined by the eye tracker subsystem and the focus property of at least a portion of the field of view of the image sensor determined by the autofocus camera. In this case: determining a gaze direction of the eye of the user by the eye tracker subsystem may include determining, by the eye tracker subsystem, a first set of two-dimensional coordinates corresponding to the at least one feature of the eye of the user; determining a focus property of at least a portion of a field of view of the image sensor by the autofocus camera may include determining a focus property of a first region in the field of view of the image sensor by the autofocus camera, the first region in the field of view of the image sensor including a second set of two-dimensional coordinates; and effecting, by the processor, a mapping between the gaze direction of the eye of the user determined by the eye tracker subsystem and the focus property of at least a portion of the field of view of the image sensor determined by the autofocus camera may include effecting, by the processor, a mapping between the first set of two-dimensional coordinates corresponding to the at least one feature of the eye of the user and the second set of two-dimensional coordinates corresponding to the first region in the field of view of the image sensor.

The method may include effecting, by the processor, a mapping between the gaze direction of the eye of the user determined by the eye tracker subsystem and a field of view of an image sensor of the autofocus camera.

The method may include receiving, by the processor, an image capture command from the user; and in response to receiving, by the processor, the image capture command from the user, executing, by the processor, the processor-executable data and/or instructions to cause the autofocus camera to focus on the object in the field of view of the eye of the user based on the gaze direction of the eye of the user determined by the eye tracker subsystem.

The method may include capturing an image of the object by the autofocus camera while the autofocus camera is focused on the object.

A wearable heads-up display may be summarized as including: a support structure that in use is worn on a head of a user; a display content generator carried by the support structure, the display content generator to provide visual display content; a transparent combiner carried by the support structure and positioned within a field of view of the user, the transparent combiner to direct visual display content provided by the display content generator to the field of view of the user; and an image capture system that comprises: an eye tracker subsystem to sense at least one feature of an eye of the user and to determine a gaze direction of the eye of the user based on the at least one feature; and an autofocus camera communicatively coupled to the eye tracker subsystem, the autofocus camera to automatically focus on an object in a field of view of the eye of the user based on the gaze direction of the eye of the user determined by the eye tracker subsystem. The autofocus camera of the wearable heads-up display may include: an image sensor having a field of view that at least partially overlaps with the field of view of the eye of the user; a tunable optical element positioned and oriented to tunably focus on the object in the field of view of the image sensor; and a focus controller communicatively coupled to the tunable optical element, the focus controller to apply adjustments to the tunable optical element to focus the field of view of the image sensor on the object in the field of view of the eye of the user based on both the gaze direction of the eye of the user determined by the eye tracker subsystem and a focus property of at least a portion of the field of view of the image sensor determined by the autofocus camera. The wearable heads-up display may further include: a processor communicatively coupled to both the eye tracker subsystem and the autofocus camera; and a non-transitory processor-readable storage medium communicatively coupled to the processor, wherein the non-transitory processor-readable storage medium stores processor-executable data and/or instructions that, when executed by the processor, cause the processor to effect a mapping between the gaze direction of the eye of the user determined by the eye tracker subsystem and the focus property of at least a portion of the field of view of the image sensor determined by the autofocus camera.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is an illustrative diagram of an image capture system that employs an eye tracker subsystem and an autofocus camera in accordance with the present systems, devices, and methods.

FIG. 2A is an illustrative diagram showing an exemplary image capture system in use and focusing on a first object in response to an eye of a user looking or gazing at (i.e., in the direction of) the first object in accordance with the present systems, devices, and methods.

FIG. 2B is an illustrative diagram showing an exemplary image capture system in use and focusing on a second object in response to an eye of a user looking or gazing at (i.e., in the direction of) the second object in accordance with the present systems, devices, and methods.

FIG. 2C is an illustrative diagram showing an exemplary image capture system in use and focusing on a third object in response to an eye of a user looking or gazing at (i.e., in the direction of) the third object in accordance with the present systems, devices, and methods.

FIG. 3 is an illustrative diagram showing an exemplary mapping (effected by an image capture system) between a gaze direction of an eye of a user and a focus property of at least a portion of a field of view of an image sensor in accordance with the present systems, devices, and methods.

FIG. 4 is a flow-diagram showing a method of operating an image capture system to autofocus on an object in the gaze direction of the user in accordance with the present systems, devices, and methods.

FIG. 5 is a flow-diagram showing a method of operating an image capture system to capture an in-focus image of an object in the gaze direction of a user in response to an image capture command from the user in accordance with the present systems, devices, and methods.

FIG. 6A is an anterior elevational view of a wearable-heads up display with an image capture system in accordance with the present systems, devices, and methods.

FIG. 6B is a posterior elevational view of the wearable-heads up display from FIG. 6A with an image capture system in accordance with the present systems, devices, and methods.

FIG. 6C is a right side elevational view of the wearable-heads up display from FIGS. 6A and 6B with an image capture system in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for autofocus cameras that automatically focus on objects in the user's field of view based on where the user is looking or gazing. More specifically, the various embodiments described herein include image capture systems in which an eye tracker subsystem is integrated with an autofocus camera to enable the user to select an object for the camera to automatically focus upon by looking or gazing at the object. Such image capture systems are particularly well-suited for use in a wearable heads-up display (“WHUD”).

Throughout this specification and the appended claims, reference is often made to an “eye tracker subsystem.” Generally, an “eye tracker subsystem” is system or device (e.g., a combination of devices) that measures, senses, detects, and/or monitors at least one feature of at least one eye of the user and determines the gaze direction of the at least one eye of the user based on the at least one feature. The at least one feature may include any or all of: a position of a pupil of the eye of the user, an orientation of a pupil of the eye of the user, a position of a cornea of the eye of the user, an orientation of a cornea of the eye of the user, a position of an iris of the eye of the user, an orientation of an iris of the eye of the user, a position of at least one retinal blood vessel of the eye of the user, and/or an orientation of at least one retinal blood vessel of the eye of the user. The at least one feature may be determined by detecting, monitoring, or otherwise sensing a reflection or glint of light from at least one of various features of the eye of the user. Various eye tracking technologies are in use today. Examples of eye tracking systems, devices, and methods that may be used in the eye tracker of the present systems, devices, and methods include, without limitation, those described in: U.S. Non-Provisional Patent Application Ser. No. 15/167,458; U.S. Non-Provisional Patent Application Ser. No. 15/167,472; U.S. Non-Provisional Patent Application Ser. No. 15/167,484; U.S. Provisional Patent Application Ser. No. 62/271,135; U.S. Provisional Patent Application Ser. No. 62/245,792; and U.S. Provisional Patent Application Ser. No. 62/281,041.

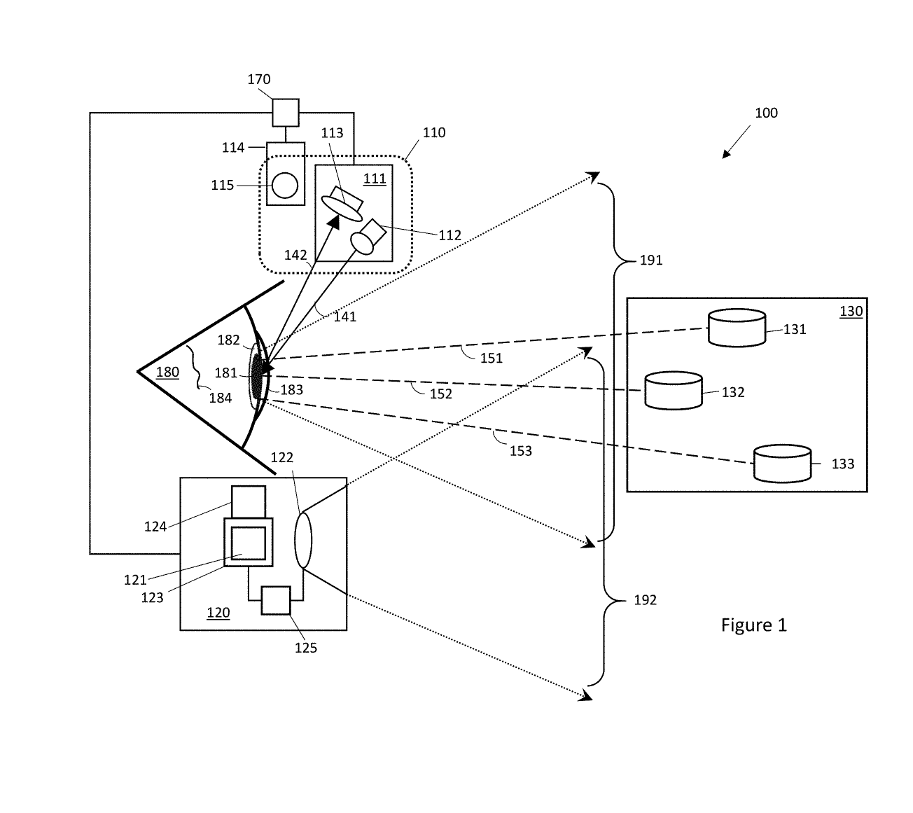

FIG. 1 is an illustrative diagram of an image capture system 100 that employs an eye tracker subsystem 110 and an autofocus camera 120 in the presence of objects 131, 132, and 133 (collectively, “130”) in the field of view 191 of an eye 180 of a user in accordance with the present systems, devices, and methods. In operation, eye tracker subsystem 110 senses at least one feature of eye 180 and determines a gaze direction of eye 180 based on the at least one feature. Autofocus camera 120 is communicatively coupled to eye tracker subsystem 110 and is configured to automatically focus on an object 130 in the field of view 191 of eye 180 based on the gaze direction of eye 180 determined by eye tracker subsystem 110. In this way, the user may simply look or gaze at a particular one of objects 131, 132, or 133 in order to cause autofocus camera 120 to focus thereon before capturing an image thereof. In FIG. 1, object 132 is closer to the user than objects 131 and 133, and object 131 is closer to the user than object 133.

Throughout this specification and the appended claims, the term “object” generally refers to a specific area (i.e., region or sub-area) in the field of view of the eye of the user and, more particularly, refers to any visible substance, matter, scenery, item, or entity located at or within the specific area in the field of view of a user. Examples of an “object” include, without limitation: a person, an animal, a structure, a building, a landscape, package or parcel, retail item, vehicle, piece of machinery, and generally any physical item upon which an autofocus camera is able to focus and of which an autofocus camera is able to capture an image.

Image capture system 100 includes at least one processor 170 (e.g., digital processor circuitry) that is communicatively coupled to both eye tracker subsystem 110 and autofocus camera 120, and at least one non-transitory processor-readable medium or memory 114 that is communicatively coupled to processor 170. Memory 114 stores, among other things, processor-executable data and/or instructions that, when executed by processor 170, cause processor 170 to control an operation of either or both of eye tracker subsystem 110 and/or autofocus camera 120.

Exemplary eye tracker subsystem 110 comprises an eye tracker 111 to sense at least one feature (e.g., pupil 181, iris 182, cornea 183, or retinal blood vessel 184) of an eye 180 of the user (as described above) and processor executable data and/or instructions 115 stored in the at least one memory 114 that, when executed by the at least one processor 170 of image capture system 100, cause the at least one processor 170 to determine the gaze direction of the eye of the user based on the at least one feature (e.g., pupil 181) of the eye 180 of the user sensed by eye tracker 111. In the exemplary implementation of image capture system 100, eye tracker 111 comprises at least one light source 112 (e.g., an infrared light source) and at least one camera or photodetector 113 (e.g., an infrared camera or infrared photodetector), although a person of skill in the art will appreciate that other implementations of the image capture systems taught herein may employ other forms and/or configurations of eye tracking components. Light signal source 112 emits a light signal 141, which is reflected or otherwise returned by eye 180 as a reflected light signal 142. Photodetector 113 detects reflected light signal 142. At least one property (e.g., brightness, intensity, time of flight, phase) of reflected light signal 142 detected by photodetector 113 depends on and is therefore indicative or representative of at least one feature (e.g., pupil 181) of eye 180 in a manner that will be generally understood by one of skill in the art. In the illustrated example, eye tracker 111 measures, detects, and/or senses at least one feature (e.g., position and/or orientation of the pupil 181, iris 182, cornea 183, or retinal blood vessels 184) of eye 180 and provides data representative of such to processor 170. Processor 170 executes data and/or instructions 115 from non-transitory processor-readable storage medium 114 to determine a gaze direction of eye 180 based on the at least one feature (e.g., pupil 181) of eye 180. As specific examples: eye tracker 111 detects at least one feature of eye 180 when eye 180 is looking or gazing towards first object 131 and processor 170 determines the gaze direction of eye 180 to be a first gaze direction 151; eye tracker 111 detects at least one feature (e.g., pupil 181) of eye 180 when eye 180 is looking or gazing towards second object 132 and processor 170 determines the gaze direction of eye 180 to be a second gaze direction 152; and eye tracker 111 detects at least one feature (e.g., pupil 181) of eye 180 when eye 180 is looking or gazing towards third object 133 and processor 170 determines the gaze direction of eye 180 to be a third gaze direction 153.

In FIG. 1, autofocus camera 120 comprises an image sensor 121 having a field of view 192 that at least partially overlaps with field of view 191 of eye 180, a tunable optical element 122 positioned and oriented to tunably focus field of view 192 of image sensor 121, and a focus controller 125 communicatively coupled to tunable optical element 122. In operation, focus controller 125 applies adjustments to tunable optical element 122 in order to focus image sensor 121 on an object 130 in field of view 191 of eye 180 based on both the gaze direction of eye 180 determined by eye tracker subsystem 110 and a focus property of at least a portion of field of view 192 of image sensor 121 determined by autofocus camera 120. To this end, autofocus camera 120 is also communicatively coupled to processor 170 and memory 114 further stores processor-executable data and/or instructions that, when executed by processor 170, cause processor 170 to effect a mapping between the gaze direction of eye 180 determined by eye tracker subsystem 110 and the focus property of at least a portion of field of view 192 of image sensor 121 determined by autofocus camera 120.

The mechanism(s) and/or technique(s) by which autofocus camera 120 determines a focus property of at least a portion of field of view 192 of image sensor 121, and the nature of the particular focus property(ies) determined, depend on the specific implementation and the present systems, devices, and methods are generic to a wide range of implementations. In the particular implementation of image capture system 100, autofocus camera 120 includes two focus property sensors 123, 124, each to determine a respective focus property of at least a portion of field of view 192 of image sensor 121. In the illustrated example, focus property sensor 123 is a phase detection sensor integrated with image sensor 121 to detect a phase difference between at least two points in field of view 192 of image sensor 121 (thus, the focus property associated with focus property sensor 123 is a phase difference between at least two points in field of view 192 of image sensor 121). In the illustrated example, focus property sensor 124 is a distance sensor discrete from image sensor 121 to sense distances to objects 130 in field of view 192 of image sensor 121 (thus, the focus property associated with focus property sensor 124 is a distance to an object 130 in field of view 192 of image sensor 121). Focus property sensors 123 and 124 are both communicatively coupled to focus controller 125 and each provide a focus property (or data representative or otherwise indicative of a focus property) thereto in order to guide or otherwise influence adjustments to tunable optical element 122 made by focus controller 125.

As an example implementation, eye tracker subsystem 110 provides information representative of the gaze direction (e.g., 152) of eye 180 to processor 170 and either or both of focus property sensor(s) 123 and/or 124 provide focus property information about field of view 192 of image sensor 121 to processor 170. Processor 170 performs a mapping between the gaze direction (e.g., 152) and the focus property information in order to determine the focusing parameters for an object 130 (e.g., 132) in field of view 191 of eye 180 along the gaze direction (e.g., 152). Processor 170 then provides the focusing parameters (or data/instructions representative thereof) to focus controller 125 and focus controller 125 adjusts tunable optical element 122 in accordance with the focusing parameters in order to focus on the particular object 130 (e.g., 132) upon which the user is gazing along the gaze direction (e.g., 132).

As another example implementation, eye tracker subsystem 110 provides information representative of the gaze direction (e.g., 152) of eye 180 to processor 170 and processor 170 maps the gaze direction (e.g., 152) to a particular region of field of view 192 of image sensor 122. Processor 170 then requests focus property information about that particular region of field of view 192 of image sensor 121 from autofocus camera 120 (either through direct communication with focus property sensor(s) 123 and/or 124 or through communication with focus controller 125 which is itself in direct communication with focus property sensor(s) 123 and/or 124), and autofocus camera 120 provides the corresponding focus property information to processor 170. Processor 170 then determines the focusing parameters (or data/instructions representative thereof) that will result in autofocus camera focusing on the object (e.g., 132) at which the user is gazing along the gaze direction and provides these focusing parameters to focus controller 125. Focus controller 125 adjusts tunable optical element 122 in accordance with the focusing parameters in order to focus on the particular object 130 (e.g., 132) upon which the user is gazing along the gaze direction (e.g., 132).

In some implementations, multiple processors may be included. For example, autofocus camera 120 (or specifically, focus controller 125) may include, or be communicatively coupled to, a second processor that is distinct from processor 170, and the second processor may perform some of the mapping and/or determining acts described in the examples above (such as determining focus parameters based on gaze direction and focus property information).

The configuration illustrated in FIG. 1 is an example only. In alternative implementations, alternative and/or additional focus property sensor(s) may be employed. For example, some implementations may employ a time of flight sensor to determine distances to objects 130 in field of view 192 of image sensor 121 (a time of flight sensor may be considered a form of distance sensor for which the distance is determined as a function of signal travel time as opposed to being sensed or measured directly) and/or a contrast detection sensor to detect an intensity difference between at least two points (e.g., pixels) in field of view 192 of image sensor 121. Some implementations may employ a single focus property sensor. In some implementations, tunable optical element 122 may be an assembly comprising multiple components.

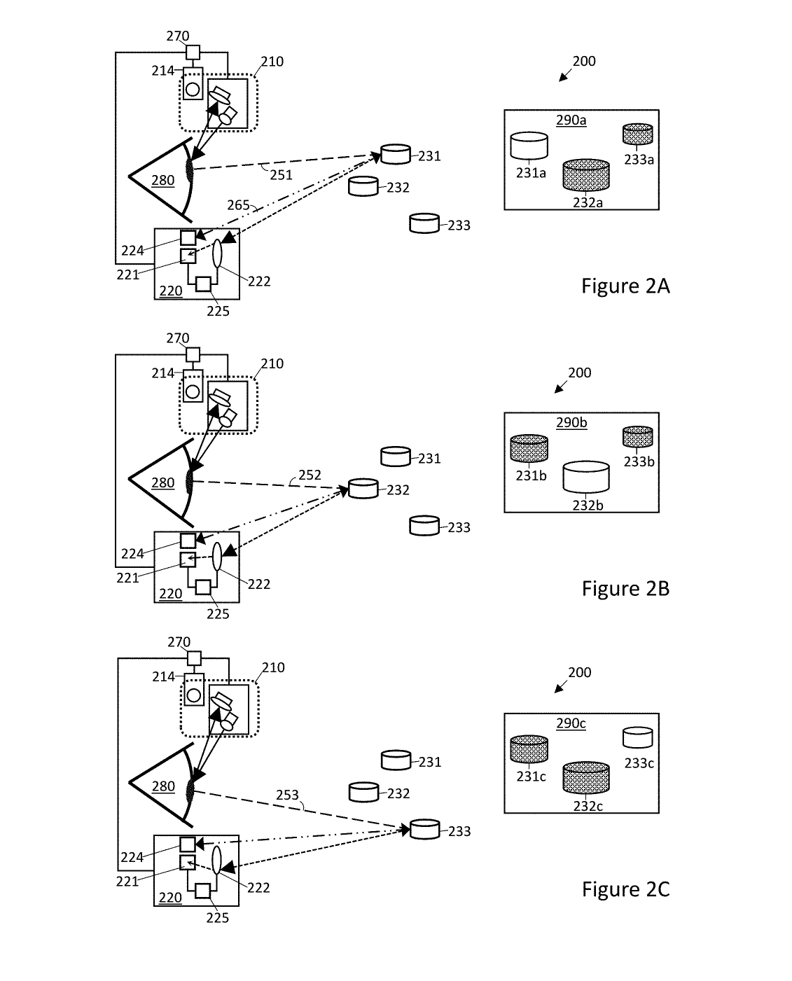

The present systems, devices, and methods are generic to the nature of the eye tracking and autofocusing mechanisms employed. The above descriptions of eye tracker subsystem 110 and autofocus camera 120 (including focus property sensor 123) are intended for illustrative purposes only and, in practice, other mechanisms for eye tracking and/or autofocusing may be employed. At a high level, the various embodiments described herein provide image capture systems (e.g., image capture system 100, and operation methods thereof) that combine eye tracking and/or gaze direction data (e.g., from eye tracker subsystem 110) and focus property data (e.g., from focus property sensor 123 and/or 124) to enable a user to select a particular one of multiple available objects for an autofocus camera to focus upon by looking at the particular one of the multiple available objects. Illustrative examples of such eye tracker-based (e.g., gaze direction-based) camera autofocusing are provided in FIGS. 2A, 2B, and 2C.

FIG. 2A is an illustrative diagram showing an exemplary image capture system 200 in use and focusing on a first object 231 in response to an eye 280 of a user looking or gazing at (i.e., in the direction of) first object 231 in accordance with the present systems, devices, and methods. Image capture system 200 is substantially similar to image capture system 100 from FIG. 1 and comprises an eye tracker subsystem 210 (substantially similar to eye tracker subsystem 110 from FIG. 1) in communication with an autofocus camera 220 (substantially similar to autofocus camera 220 from FIG. 1). A set of three objects 231, 232, and 233 are present in the field of view of eye 280 of the user, each of which are at different distances from eye 280, object 232 being the closest object to the user and object 233 being the furthest object from the user. In FIG. 2A, the user is looking/gazing towards first object 231 and eye tracker subsystem 210 determines the gaze direction 251 of eye 280 that corresponds to the user looking/gazing at first object 231. Data/information representative of or otherwise about gaze direction 251 is sent from eye tracker subsystem 210 to processor 270, which effects a mapping (e.g., based on executing data and/or instructions stored in a non-transitory processor-readable storage medium 214 communicatively coupled thereto) between gaze direction 251 and the field of view of the image sensor 221 in autofocus camera 220 in order to determine at least approximately where in the field of view of image sensor 221 the user is looking/gazing.

Exemplary image capture system 200 is distinct from exemplary image capture system 100 in that image capture system 200 employs different focus property sensing mechanisms than image capture system 100. Specifically, image capture system 200 does not include a phase detection sensor 123 and, instead, image sensor 221 in autofocus camera 220 is adapted to enable contrast detection. Generally, light intensity data/information from various (e.g., adjacent) ones of the pixels/sensors of image sensor 221 are processed (e.g., by processor 270, or by focus controller 225, or by another processor in image capture system 200 (not shown)) and compared to identify or otherwise determine intensity differences. Areas or regions of image sensor 221 that are “in focus” tend to correspond to areas/regions where the intensity differences between adjacent pixels are the largest.

Additionally, focus property sensor 224 in image capture system 200 is a time of flight sensor to determine distances to objects 231, 232, and/or 233 in the field of view of image sensor 221. Thus, contrast detection and/or time-of-flight detection are used in image capture system 200 to determine one or more focus property(ies) (i.e., contrast and/or distance to objects) of at least the portion of the field of view of image sensor 221 that corresponds to where the user is looking/gazing when the user is looking/gazing along gaze direction 251. Either or both of contrast detection by image sensor 221 and/or distance determination by time-of-flight sensor 224 may be employed together or individually, or in addition to, or may be replaced by, other focus property sensors such as a phase detection sensor and/or another form of distance sensor. The focus property(ies) determined by image sensor 221 and/or time-of-flight sensor 224 is/are sent to focus controller 225 which, based thereon, applies adjustments to tunable optical element 222 to focus the field of view of image sensor 221 on first object 231. Autofocus camera 220 may then (e.g., in response to an image capture command from the user) capture a focused image 290a of first object 231. The “focused” aspect of first object 231 is represented in the illustrative example of image 290a by the fact that first object 231a is drawn as an unshaded volume while objects 232a and 233a are both shaded (i.e., representing unfocused).

Generally, any or all of: the determining of the gaze direction by eye tracker subsystem 210, the mapping of the gaze direction to a corresponding region of the field of view of image sensor 221 by processor 270, the determining of a focus property of at least that region of the field of view of image sensor 221 by contrast detection and/or time-of-flight detection, and/or the adjusting of tunable optical element 222 to focus that region of the field of view of image sensor 221 by focus controller 225 may be performed continuously or autonomously (e.g., periodically at a defined frequency) in real time and an actual image 290a may only be captured in response to an image capture command from the user, or alternatively any all of the foregoing may only be performed in response to an image capture command from the user.

FIG. 2B is an illustrative diagram showing exemplary image capture system 200 in use and focusing on a second object 232 in response to eye 280 of the user looking or gazing at (i.e., in the direction of) second object 232 in accordance with the present systems, devices, and methods. In FIG. 2B, the user is looking/gazing towards second object 232 and eye tracker subsystem 210 determines the gaze direction 252 of eye 280 that corresponds to the user looking/gazing at second object 232. Data/information representative of or otherwise about gaze direction 252 is sent from eye tracker subsystem 210 to processor 270, which effects a mapping (e.g., based on executing data and/or instructions stored in non-transitory processor-readable storage medium 214 communicatively coupled thereto) between gaze direction 252 and the field of view of image sensor 221 in autofocus camera 220 in order to determine at least approximately where in the field of view of image sensor 221 the user is looking/gazing. For the region in the field of view of image sensor 221 that corresponds to where the user is looking/gazing when the user is looking/gazing along gaze direction 252, image sensor 221 may determine contrast (e.g., relative intensity) information and/or time-of-flight sensor 224 may determine object distance information. Either or both of these focus properties is/are sent to focus controller 225 which, based thereon, applies adjustments to tunable optical element 222 to focus the field of view of image sensor 221 on second object 232. Autofocus camera 220 may then (e.g., in response to an image capture command from the user) capture a focused image 290b of second object 232. The “focused” aspect of second object 232 is represented in the illustrative example of image 290b by the fact that second object 232b is drawn as an unshaded volume while objects 231b and 233b are both shaded (i.e., representing unfocused).

FIG. 2C is an illustrative diagram showing exemplary image capture system 200 in use and focusing on a third object 233 in response to eye 280 of the user looking or gazing at (i.e., in the direction of) third object 233 in accordance with the present systems, devices, and methods. In FIG. 2C, the user is looking/gazing towards third object 233 and eye tracker subsystem 210 determines the gaze direction 253 of eye 280 that corresponds to the user looking/gazing at third object 233. Data/information representative of or otherwise about gaze direction 253 is sent from eye tracker subsystem 210 to processor 270, which effects a mapping (e.g., based on executing data and/or instructions stored in non-transitory processor-readable storage medium 214 communicatively coupled thereto) between gaze direction 253 and the field of view of image sensor 221 in autofocus camera 220 in order to determine at least approximately where in the field of view of image sensor 221 the user is looking/gazing. For the region in the field of view of image sensor 221 that corresponds to where the user is looking/gazing when the user is looking/gazing along gaze direction 253, image sensor 221 may determine contrast (e.g., relative intensity) information and/or time-of-flight sensor 224 may determine object distance information. Either or both of these focus properties is/are sent to focus controller 225 which, based thereon, applies adjustments to tunable optical element 222 to focus the field of view of image sensor 221 on third object 233. Autofocus camera 220 may then (e.g., in response to an image capture command from the user) capture a focused image 290c of third object 233. The “focused” aspect of third object 233 is represented in the illustrative example of image 290c by the fact that third object 233c is drawn in clean lines as an unshaded volume while objects 231c and 232c are both shaded (i.e., representing unfocused).

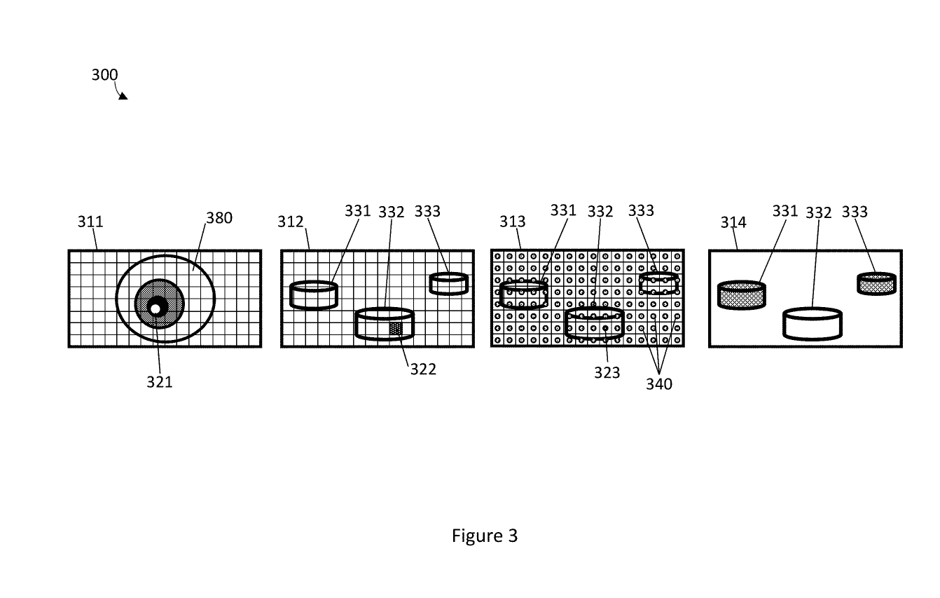

FIG. 3 is an illustrative diagram showing an exemplary mapping 300 (effected by an image capture system) between a gaze direction of an eye 380 of a user and a focus property of at least a portion of a field of view of an image sensor in accordance with the present systems, devices, and methods. Mapping 300 depicts four fields of view: field of view 311 is the field of view of an eye tracker component of the eye tracker subsystem and shows eye 380; field of view 312 is a representation of the field of view of eye 380 and shows objects 331, 332, and 333; field of view 313 is the field of view of a focus property sensor component of the autofocus camera and also shows objects 331, 332, and 333; and field of view 314 is the field of view of the image sensor component of the autofocus camera and also shows objects 331, 332, and 333. In the illustrated example, field of view 314 of the image sensor is substantially the same as field of view 312 of eye 380, though in alternative implementations field of view 314 of the image sensor may only partially overlap with field of view 312 of eye 380. In the illustrated example, field of view 313 of the focus property sensor is substantially the same as field of view 314 of the image sensor, though in alternative implementations field of view 314 may only partially overlap with field of view 313 or field of view 314 may be smaller than field of view 313 and field of view 314 may be completely contained within field of view 313. Object 332 is closer to the user than objects 331 and 333, and object 331 is closer to the user than object 333.

As noted above field of view 311 represents the field of view of an eye tracker component of the eye tracker subsystem. A feature 321 of eye 380 is sensed, identified, measured, or otherwise detected by the eye tracker. Feature 321 may include, for example, a position and/or orientation of a component of the eye, such as the pupil, the iris, the cornea, or one or more retinal blood vessel(s). In the illustrated example, feature 321 corresponds to a position of the pupil of eye 380. In the particular implementation of mapping 300, field of view 311 is overlaid by a grid pattern that divides field of view 311 up into a two-dimensional “pupil position space.” Thus, the position of the pupil of eye 380 is characterized in field of view 311 by the two-dimensional coordinates corresponding to the location of the pupil of eye 380 (i.e., the location of feature 321) in two-dimensional pupil position space. Alternatively, other coordinate systems can be employed, for example a radial coordinate system. In operation, feature 321 may be sensed, identified, measured, or otherwise detected by the eye tracker component of an eye tracker subsystem and the two-dimensional coordinates of feature 321 may be determined by a processor communicatively coupled to the eye tracker component.

As noted above field of view 312 represents the field of view of eye 380 and is also overlaid by a two-dimensional grid to establish a two-dimensional “gaze direction space.” Field of view 312 may be the actual field of view of eye 380 or it may be a model of the field of view of eye 380 stored in memory and accessed by the processor. In either case, the processor maps the two-dimensional position of feature 321 from field of view 311 to a two-dimensional position in field of view 312 in order to determine the gaze direction 322 of eye 380. As illustrated, gaze direction 322 aligns with object 332 in the field of view of the user.

As noted above field of view 313 represents the field of view of a focus property sensor component of the autofocus camera and is also overlaid by a two-dimensional grid to establish a two-dimensional “focus property space.” The focus property sensor may or may not be integrated with the image sensor of the autofocus camera such that the field of view 313 of the focus property sensor may or may not be the same as the field of view 314 of the image sensor. Various focus properties (e.g., distances, pixel intensities for contrast detection, and so on) 340 are determined at various points in field of view 313. In mapping 300, the processor maps the gaze direction 322 from field of view 312 to a corresponding point in the two-dimensional focus property space of field of view 313 and identifies or determines the focus property 323 corresponding to that point. At this stage in mapping 300, the image capture system has identified the gaze direction of the user, determined that the user is looking or gazing at object 332, and identified or determined a focus property of object 332. In accordance with the present systems, devices, and methods, the processor may then determine one or more focusing parameter(s) in association with object 332 and instruct a focus controller of the autofocus camera to focus the image sensor (e.g., by applying adjustments to one or more tunable optical element(s) or lens(es)) on object 332 based on the one or more focus parameter(s).

As noted above field of view 314 is the field of view of the image sensor of the autofocus camera. Field of view 314 is focused on object 332 and not focused on objects 331 and 333, as indicated by object 332 being drawn with no volume shading while objects 331 and 333 are both drawn shaded (i.e., representing being out of focus). Object 332 is in focus while objects 331 and 333 are not because, as determined through mapping 300, object 332 corresponds to where the user is looking/gazing while object 331 and 333 do not. At this stage, if so desired (e.g., instructed) by the user, the image capture system may capture an image of object 332 corresponding to field of view 314.

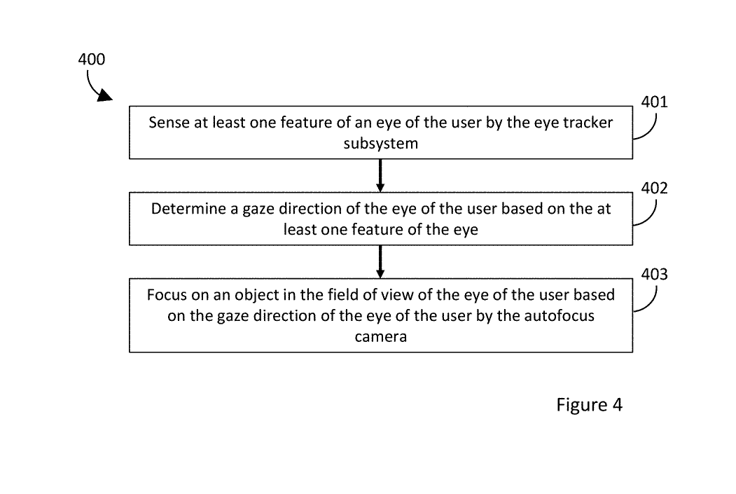

FIG. 4 shows a method 400 of operating an image capture system to autofocus on an object in the gaze direction of the user in accordance with the present systems, devices, and methods. The image capture system may be substantially similar or even identical to image capture system 100 in FIG. 1 and/or image capture system 200 in FIGS. 2A, 2B, and 2C and generally includes an eye tracker subsystem and an autofocus camera with communicative coupling (e.g., through one or more processor(s)) therebetween. Method 400 includes three acts 401, 402, and 403. Those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 401, the eye tracker subsystem senses at least one feature of the eye of the user. More specifically, the eye tracker subsystem may include an eye tracker and the eye tracker of the eye tracking subsystem may sense at least one feature of the eye of the user according to any of the wide range of established techniques for eye tracking with which a person of skill in the art will be familiar. As previously described, the at least one feature of the eye of the user sensed by the eye tracker may include any one or combination of the position and/or orientation of: a pupil of the eye of the user, a cornea of the eye of the user, an iris of the eye of the user, or at least one retinal blood vessel of the eye of the user.

At 402, the eye tracker subsystem determines a gaze direction of the eye of the user based on the at least one feature of the eye of the user sensed by the eye tracker subsystem at 401. More specifically, the eye tracker subsystem may include or be communicatively coupled to a processor and that processor may be communicatively coupled to a non-transitory processor-readable storage medium or memory. The memory may store processor-executable data and/or instructions (generally referred to herein as part of the eye tracker subsystem, e.g., data/instructions 115 in FIG. 1) that, when executed by the processor, cause the processor to determine the gaze direction of the eye of the user based on the at least one feature of the eye of the user sensed by the eye tracker.

At 403, the autofocus camera focuses on an object in the field of view of the eye of the user based on the gaze direction of the eye of the user determined by the eye tracker subsystem at 402. When the image capture system includes a processor and a memory, the processor may execute data and/or instructions stored in the memory to cause the autofocus camera to focus on the object in the field of view of the eye of the user based on the gaze direction of the eye of the user.

Generally, the autofocus camera may include an image sensor, a tunable optical element positioned in the field of view of the image sensor to controllably focus light on the image sensor, and a focus controller communicatively coupled to the tunable optical element to apply adjustments thereto in order to control the focus of light impingent on the image sensor. The field of view of the image sensor may at least partially (e.g., completely or to a large extent, such as by 80% or greater) overlap with the field of view of the eye of the user. In an extended version of method 400, the autofocus camera may determine a focus property of at least a portion of the field of view of the image sensor. In this case, at 403 the focus controller of the autofocus camera may adjust the tunable optical element to focus the field of view of the image sensor on the object in the field of view of the eye of the user, and such adjustment may be based on both the gaze direction of the eye of the user determined by the eye tracker subsystem at 402 and the focus property of at least a portion of the field of view of the image sensor determined by the autofocus camera.

The focus property determined by the autofocus camera at 403 may include a contrast differential across at least two points (e.g., pixels) of the image sensor. In this case, the image sensor may serve as a focus property sensor (i.e., specifically a contrast detection sensor) and be communicatively coupled to a processor and non-transitory processor readable storage medium that stores processor-executable data and/or instructions that, when executed by the processor, cause the processor to compare the relative intensities of at least two proximate (e.g., adjacent) points or regions (e.g., pixels) of the image sensor in order to determine the region of the field of view of the image sensor upon which light impingent on the image sensor (through the tunable optical element) is focused. Generally, the region of the field of view of the image sensor that is in focus may correspond to the region of the field of view of the image sensor for which the pixels of the image sensor show the largest relative changes in intensity, corresponding to the sharpest edges in the image.

Either in addition to or instead of contrast detection, in some implementations the autofocus camera may include at least one dedicated focus property sensor to determine the focus property of at least a portion of the field of view of the image sensor at 403. As examples, at 403 a distance sensor of the autofocus camera may sense a distance to the object in the field of view of the image sensor, a time of flight sensor may determine a distance to the object in the field of view of the image sensor, and/or a phase detection sensor may detect a phase difference between at least two points in the field of view of the image sensor.

The image capture systems, devices, and methods described herein include various components (e.g., an eye tracker subsystem and an autofocus camera) and, as previously described, may include effecting one or more mapping(s) between data/information collected and/or used by the various components. Generally, any such mapping may be effected by one or more processor(s). As an example, in method 400 at least one processor may effect a mapping between the gaze direction of the eye of the user determined by the eye tracker subsystem at 402 and the field of view of the image sensor in order to identify or otherwise determine the location, region, or point in the field of view of the image sensor that corresponds to where the user is looking or gazing. In other words, the location, region, or point (e.g., the object) in the field of view of the user at which the user is looking or gazing is determined by the eye tracker subsystem and then this location, region, or point (e.g., object) is mapped by a processor to a corresponding location, region, or point (e.g., object) in the field of view of the image sensor. In accordance with the present systems, devices, and methods, once the location, region, or point (e.g., object) in the field of view of the image sensor that corresponds to where the user is looking or gazing is established, the image capture system may automatically focus on that location, region, or point (e.g., object) and, if so desired, capture a focused image of that location, region, or point (e.g., object). In order to facilitate or enable focusing on the location, region, or point (e.g., object), the at least one processor may effect a mapping between the gaze direction of the eye of the user determined by the eye tracker subsystem at 402 and one or more focus property(ies) of at least a portion of the field of view of the image sensor determined by the autofocus camera (e.g., by at least one focus property sensor of the autofocus camera) at 403. Such provides a focus property of the location, region, or point (e.g., object) in the field of view of the image sensor corresponding to the location, region, or point (e.g., object) at which the user is looking or gazing. The focus controller of the autofocus camera may use data/information about this/these focus property(ies) to apply adjustments to the tunable optical element such that light impingent on the image sensor is focused on the location, region, or point (e.g., object) at which the user is looking or gazing.

As previously described, when a processor (or processors) effects a mapping, such a mapping may include or be based on coordinate systems. For example, at 402 the eye tracker subsystem may determine a first set of two-dimensional coordinates that correspond to the at least one feature of the eye of the user (e.g., in “pupil position space”) and translate, convert, or otherwise represent the first set of two-dimensional coordinates as a gaze direction in a “gaze direction space.” The field of view of the image sensor in the autofocus camera may similarly be divided up into a two-dimensional “image sensor space,” and at 403 the autofocus camera may determine a focus property of at least one region (i.e., corresponding to a second set of two-dimensional coordinates) in the field of view of the image sensor. This way, if and when at least one processor effects a mapping between the gaze direction of the eye of the user and the focus property of at least a portion of the field of view of the image sensor (as previously described), the at least one processor may effect a mapping between the first set of two-dimensional coordinates corresponding to the at least one feature and/or gaze direction of the eye of the user and the second set of two-dimensional coordinates corresponding to a particular region of the field of view of the image sensor.

If and when the autofocus camera determines a focus property of at least one region (i.e., corresponding to the second set of two-dimensional coordinates) in the field of view of the image sensor, the processor may either: i) consistently (e.g., at regular intervals or continuously) monitor a focus property over the entire field of view of the image sensor and return the particular focus property corresponding to the particular second set of two-dimensional coordinates as part of the mapping at 403, or ii) identify or otherwise determine the second set of two-dimensional coordinates as part of the mapping at 403 and return the focus property corresponding to the second set of two-dimensional coordinates.

As previously described, in some implementations an image capture system may consistently (e.g., at regular intervals or continuously) monitor a user's gaze direction (via an eye tracker subsystem) and/or consistently (e.g., at regular intervals or continuously) monitor one or more focus property(ies) of the field of view of an autofocus camera. In other words, an image capture system may consistently or repeatedly perform method 400 and only capture an actual image of an object (e.g., store a copy of an image of the image in memory) in response to an image capture command from the user. In other implementations, the eye tracker subsystem and/or autofocus camera components of an image capture system may remain substantially inactive (i.e., method 400 may not be consistently performed) until the image capture system receives an image capture command from the user.

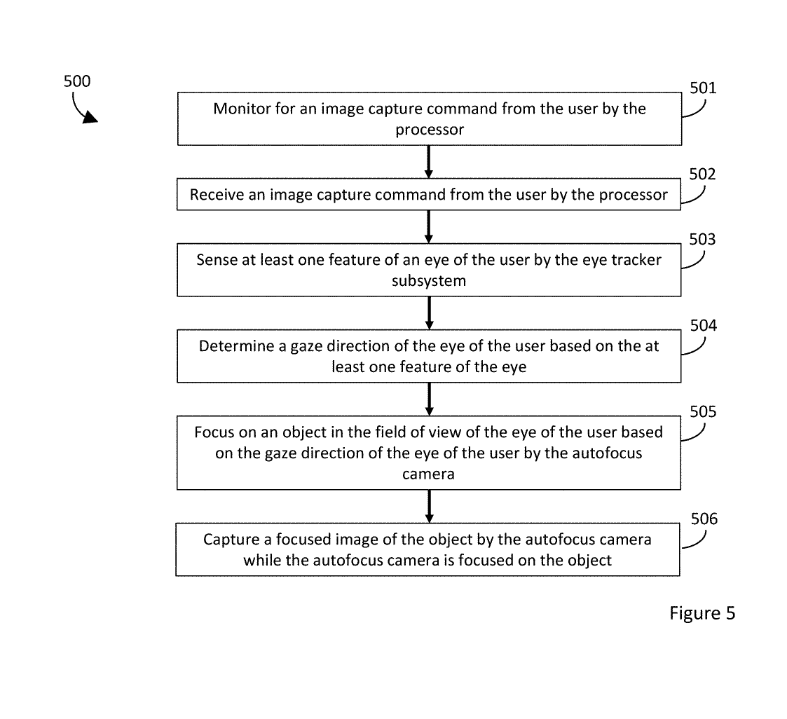

FIG. 5 shows a method 500 of operating an image capture system to capture an in-focus image of an object in the gaze direction of a user in response to an image capture command from the user in accordance with the present systems, devices, and methods. The image capture system may be substantially similar or even identical to image capture system 100 from FIG. 1 and/or image capture system 200 from FIGS. 2A, 2B, and 2C and generally includes an eye tracker subsystem and an autofocus camera, both communicatively coupled to a processor (and, typically, a non-transitory processor-readable medium or memory storing processor-executable data and/or instructions that, when executed by the processor, cause the image capture system to perform method 500). Method 500 includes six acts 501, 502, 503, 504, 505, and 506, although those of skill in the art will appreciate that in alternative embodiments certain acts may be omitted and/or additional acts may be added. Those of skill in the art will also appreciate that the illustrated order of the acts is shown for exemplary purposes only and may change in alternative embodiments. Acts 503, 504, and 505 are substantially similar to acts 401, 402 and 403, respectively, of method 400 and are not discussed in detail below to avoid duplication.

At 501, the processor monitors for an occurrence or instance of an image capture command from the user. The processor may execute instructions from the non-transitory processor-readable storage medium that cause the processor to monitor for the image capture command from the user. The nature of the image capture command from the user may come in a wide variety of different forms depending on the implementation and, in particular, on the input mechanisms for the image capture system. As examples: in an image capture system that employs a touch-based interface (e.g., one or more touchscreens, buttons, capacitive or inductive switches, contact switches), the image capture command may include an activation of one or more touch-based inputs; in an image capture system that employs voice commands (e.g., at least one microphone and an audio processing capability), the image command may include a particular voice command; and/or in an image capture system that employs gesture control (e.g., optical or infrared, or ultrasonic-based gesture detection or EMG-based gesture detection such as the Myo™ armband), the image capture command may include at least one gestural input. In some implementations, the eye tracker subsystem of the image capture system may be used to monitor for an identify an image capture command from the user using an interface similar to that described in U.S. Provisional Patent Application Ser. No. 62/236,060 and/or U.S. Provisional Patent Application Ser. No. 62/261,653.

At 502, the processor of the image capture system receives the image capture command from the user. In some implementations, the image capture command may be directed towards immediately capturing an image, while in other implementations the image capture command may be directed towards initiating, executing, or otherwise activating a camera application or other software application(s) stored in the non-transitory processor-readable storage medium of the image capture system.

In response to the processor receiving the image capture command from the user at 502, method 500 proceeds to acts 503, 504, and 505, which essentially perform method 400 from FIG. 4.

At 503, the eye tracker subsystem senses at least one feature of the eye of the user in a manner similar to that described for act 401 of method 400. The eye tracker subsystem may provide data/information indicative or otherwise representative of the at least one feature data to the processor.

At 504, the eye tracker subsystem determines a gaze direction of the eye of the user based on the at least one feature of the eye of the user sensed at 503 in a manner substantially similar to that described for act 402 of method 400.

At 505, the autofocus camera focuses on an object in the field of view of the eye of the user based on the gaze direction of the eye of the user determined at 504 in a manner substantially similar to that described for act 403 of method 400.

At 506, the autofocus camera of the image capture system captures a focused image of the object while the autofocus camera is focused on the object per 505. In some implementations, the autofocus camera may record or copy a digital photograph or image of the object and store the digital photograph or image in a local memory or transmit the digital photograph or image for storage in a remote or off-board memory. In other implementations, the autofocus camera may capture visual information from the object without necessarily recording or storing the visual information (e.g., for the purpose of displaying or analyzing the visual information, such as in a viewfinder or in real-time on a display screen). In still other implementations, the autofocus camera may capture a plurality of images of the object at 506 as a “burst” of images or as respective frames of a video.

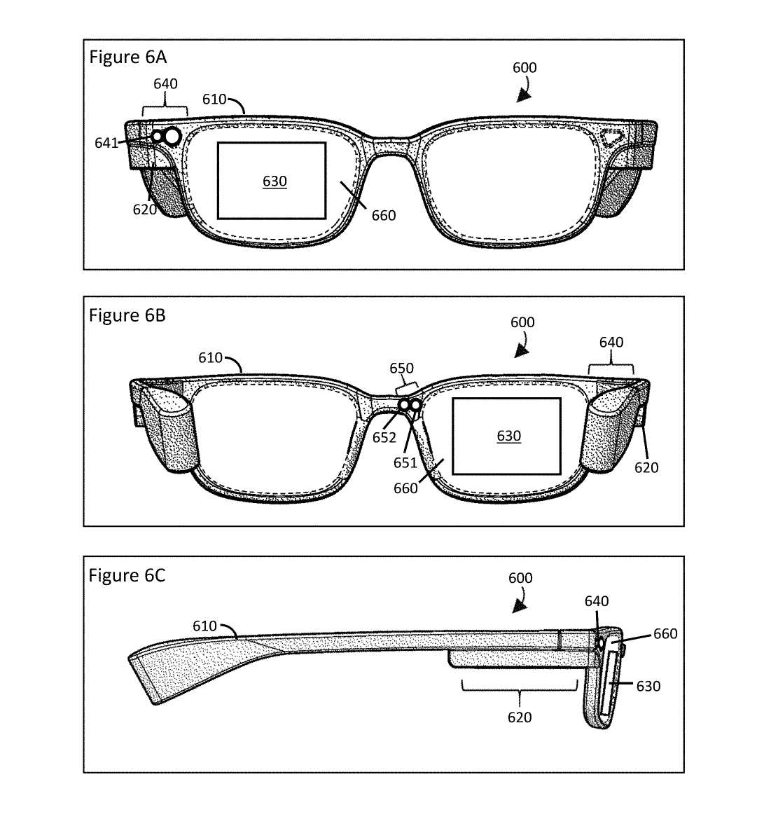

As previously described, the present image capture systems, devices, and methods that autofocus based on eye tracking and/or gaze direction detection are particularly well-suited for use in WHUDs. Illustrative examples of a WHUD that employs the image capture systems, devices, and methods described herein are provided in FIGS. 6A, 6B, and C.

FIG. 6A is a front view of a WHUD 600 with a gaze direction-based autofocus image capture system in accordance with the present systems devices and methods. FIG. 6B is a posterior view of WHUD 600 from FIG. 6A and FIG. 6C is a side or lateral view of WHUD 600 from FIG. 6A. With reference to each of FIGS. 6A, 6B, and 6C, WHUD 600 includes a support structure 610 that in use is worn on the head of a user and has a general shape and appearance of an eyeglasses frame. Support structure 610 carries multiple components, including: a display content generator 620 (e.g., a projector or microdisplay and associated optics), a transparent combiner 630, an autofocus camera 640, and an eye tracker 650 comprising an infrared light source 651 and an infrared photodetector 652. In FIG. 6A, autofocus camera 640 includes at least one focus property sensor 641 shown as a discrete element. Portions of display content generator 620, autofocus camera 640, and eye tracker 650 may be contained within an inner volume of support structure 610. For example, WHUD 600 may also include a processor communicatively coupled to autofocus camera 640 and eye tracker 650 and a non-transitory processor-readable storage medium communicatively coupled to the processor, where both the processor and the storage medium are carried within one or more inner volume(s) of support structure 610 and so not visible in the views of FIGS. 6A, 6B, and 6C.

Throughout this specification and the appended claims, the term “carries” and variants such as carried by are generally used to refer to a physical coupling between two objects. The physical coupling may be direct physical coupling (i.e., with direct physical contact between the two objects) or indirect physical coupling mediated by one or more additional objects. Thus the term carries and variants such as “carried by” are meant to generally encompass all manner of direct and indirect physical coupling.

Display content generator 620, carried by support structure 610, may include a light source and an optical system that provides display content in cooperation with transparent combiner 630. Transparent combiner 630 is positioned within a field of view of an eye of the user when support structure 610 is worn on the head of the user. Transparent combiner 630 is sufficiently optically transparent to permit light from the user's environment to pass through to the user's eye, but also redirects light from display content generator 620 towards the user's eye. In FIGS. 6A, 6B, and 6C, transparent combiner 630 is a component of a transparent eyeglass lens 660 (e.g. a prescription eyeglass lens or a non-prescription eyeglass lens). WHUD 600 carries one display content generator 620 and one transparent combiner 630; however, other implementations may employ binocular displays, with a display content generator and transparent combiner for both eyes.

Autofocus camera 640, comprising an image sensor, a tunable optical element, a focus controller, and a discrete focus property sensor 641, is carried on the right side (user perspective per the rear view of FIG. 6B) of support structure 610. However, in other implementations autofocus camera 640 may be carried on either side or both sides of WHUD 600. Focus property sensor 641 is physically distinct from the image sensor of autofocus camera 640, however, in some implementations, focus property sensor 641 may be of a type integrated into the image sensor (e.g., a contrast detection sensor).

The light signal source 651 and photodetector 652 of eye tracker 650 are, for example, carried on the middle of support frame 610 between the eyes of the user and directed towards tracking the right eye of the user. A person of skill in the art will appreciate that in alternative implementations eye tracker 650 may be located elsewhere on support structure 610 and/or may be oriented to track the left eye of the user, or both eyes of the user. In implementations that track both eyes of the user, vergence data/information of the eyes may be used as a focus property to influence the depth at which the focus controller of the autofocus camera causes the tunable optical element to focus light that is impingent on the image sensor. For example, autofocus camera 640 may automatically focus to a depth corresponding to a vergence of both eyes determined by an eye tracker subsystem and the image capture system may capture an image focused at that depth without necessarily determining the gaze direction and/or object of interest of the user.

In any of the above implementations, multiple autofocus cameras may be employed. The multiple autofocus cameras may each autofocus on the same object in the field of view of the user in response to a gaze direction information from a single eye-tracking subsystem. The multiple autofocus cameras may be stereo or non-stereo, and may capture images that are distinct or that contribute to creating a single image.

Examples of WHUD systems, devices, and methods that may be used as or in relation to the WHUDs described in the present systems, devices, and methods include, without limitation, those described in: US Patent Publication No. US 2015-0205134 A1, US Patent Publication No. US 2015-0378164 A1, US Patent Publication No. US 2015-0378161 A1, US Patent Publication No. US 2015-0378162 A1, U.S. Non-Provisional Patent Application Ser. No. 15/046,234; U.S. Non-Provisional Patent Application Ser. No. 15/046,254; and/or U.S. Non-Provisional Patent Application Ser. No. 15/046,269.

A person of skill in the art will appreciate that the various embodiments described herein for image capture systems, devices, and methods that focus based eye tracking may be applied in non-WHUD applications. For example, the present systems, devices, and methods may be applied in non-wearable heads-up displays (i.e., heads-up displays that are not wearable) and/or in other applications that may or may not include a visible display.

The WHUDs and/or image capture systems described herein may include one or more sensor(s) (e.g., microphone, camera, thermometer, compass, altimeter, barometer, and/or others) for collecting data from the user's environment. For example, one or more camera(s) may be used to provide feedback to the processor of the WHUD and influence where on the display(s) any given image should be displayed.

The WHUDs and/or image capture systems described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs and/or image capture systems described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional Patent Application Ser. No. 14/155,087, U.S. Non-Provisional Patent Application Ser. No. 14/155,107, and/or PCT Patent Application PCT/US2014/057029, all of which are incorporated by reference herein in their entirety.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other image capture systems, or portable and/or wearable electronic devices, not necessarily the exemplary image capture systems and wearable electronic devices generally described above.

For instance, the foregoing detailed description has set forth various embodiments of the systems, devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more processors, for instance one or more Application Specific Integrated Circuits (ASICs). However, those skilled in the art will recognize that the embodiments disclosed herein, in whole or in part, can be equivalently implemented in standard or generic integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units (CPUs), graphical processing units (GPUs), programmable gate arrays (PGAs), programmed logic controllers (PLCs)), as firmware, or as virtually any combination thereof, and that designing the circuitry and/or writing the code for the software and or firmware would be well within the skill of one of ordinary skill in the art in light of the teachings of this disclosure. As used herein and in the claims, the terms processor or processors refer to hardware circuitry, for example ASICs, microprocessors, CPUs, GPUs, PGAs, PLCs, and other microcontrollers.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any hardware that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Non-Provisional Patent Application Ser. No. 15/639,371, US Patent Publication No. US 2015-0205134 A1, US Patent Publication No. US 2015-0378164 A1, US Patent Publication No. US 2015-0378161 A1, US Patent Publication No. US 2015-0378162 A1, U.S. Non-Provisional Patent Application Ser. No. 15/046,234, U.S. Non-Provisional Patent Application Ser. No. 15/046,254, U.S. Non-Provisional Patent Application Ser. No. 15/046,269, U.S. Non-Provisional Patent Application Ser. No. 15/167,458, U.S. Non-Provisional Patent Application Ser. No. 15/167,472, U.S. Non-Provisional Patent Application Ser. No. 15/167,484, U.S. Provisional Patent Application Ser. No. 62/271,135, U.S. Provisional Patent Application Ser. No. 62/245,792, U.S. Provisional Patent Application Ser. No. 62/281,041, U.S. Non-Provisional Patent Application Ser. No. 14/155,087, U.S. Non-Provisional Patent Application Ser. No. 14/155,107, PCT Patent Application PCT/US2014/057029, U.S. Provisional Patent Application Ser. No. 62/236,060, and/or U.S. Provisional Patent Application Ser. No. 62/261,653, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display (“WHUD”) comprising:
a support structure that in use is worn on a head of a user;
a display content generator carried by the support structure, the display content generator to provide visual display content;
a transparent combiner carried by the support structure and positioned within a field of view of the user, the transparent combiner to direct visual display content provided by the display content generator to the field of view of the user; and
an image capture system that comprises:
an eye tracker subsystem to sense at least one feature of an eye of the user and to determine a gaze direction of the eye of the user based on the at least one feature; and
an autofocus camera communicatively coupled to the eye tracker subsystem, the autofocus camera to automatically focus on an object in a field of view of the eye of the user based on the gaze direction of the eye of the user determined by the eye tracker subsystem.

2. The WHUD of claim 1 wherein the autofocus camera includes:
an image sensor having a field of view that at least partially overlaps with the field of view of the eye of the user;
a tunable optical element positioned and oriented to tunably focus on the object in the field of view of the image sensor; and
a focus controller communicatively coupled to the tunable optical element, the focus controller to apply adjustments to the tunable optical element to focus the field of view of the image sensor on the object in the field of view of the eye of the user based on both the gaze direction of the eye of the user determined by the eye tracker subsystem and a focus property of at least a portion of the field of view of the image sensor determined by the autofocus camera.

3. The WHUD of claim 2, further comprising:
a processor communicatively coupled to both the eye tracker subsystem and the autofocus camera; and
a non-transitory processor-readable storage medium communicatively coupled to the processor, wherein the non-transitory processor-readable storage medium stores processor-executable data and/or instructions that, when executed by the processor, cause the processor to effect a mapping between the gaze direction of the eye of the user determined by the eye tracker subsystem and the focus property of at least a portion of the field of view of the image sensor determined by the autofocus camera.
